(19) United States
(12) Patent Application Publication
(10) Pub. No.: US 2005/0210428 A1
(43) Pub. Date: Sep. 22, 2005

(54) System and method for flattening hierarchical designs in VLSI circuit analysis tools

(76) Inventors: S. Brandon Keller, Evans, CO (US); Gregory Dennis Rogers, Ft. Collins, CO (US); George Harold Robbert, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/803,693

(22) Filed: Mar. 18, 2004

(51) Int. Cl. G06F 17/50

(52) U.S. Cl. 716/4

(57) ABSTRACT

One embodiment is a method for enabling a first circuit analysis tool to flatten a hierarchical design for processing by a second circuit analysis tool. The method comprises reading a logical representation of the hierarchical design; and, for each block of the hierarchical design, loading RC information for the block from an RC model of the hierarchical design and writing a flat representation of each instantiation of the block to the second circuit analysis tool.

### CROSS-REFERENCE TO RELATED APPLICATIONS

This application is related to the following commonly-owned, co-pending U.S. patent applications: U.S. patent application Ser. No. ______, filed ______ entitled “SYSTEM AND METHOD TO OPTIMIZE LOGICAL CONFIGURATION RELATIONSHIPS IN VLSI CIRCUIT ANALYSIS TOOLS” (Docket No. 200311735-1); U.S. patent application Ser. No. ______, filed ______ entitled “SYSTEM AND METHOD FOR FACILITATING EFFICIENT APPLICATION OF LOGICAL CONFIGURATION INFORMATION IN VLSI CIRCUIT ANALYSIS TOOLS” (Docket No. 200311736-1); U.S. patent application Ser. No. ______, filed ______ entitled “SYSTEM AND METHOD TO PRIORITIZE AND SELECTIVELY APPLY CONFIGURATION INFORMATION FOR VLSI CIRCUIT ANALYSIS TOOLS” (Docket No. 200311762-1); U.S. patent application Ser. No. ______, filed ______ entitled “SYSTEM AND METHOD FOR CONTROLLING ANALYSIS OF MULTIPLE INSTANTIATIONS OF CIRCUITS IN HIERARCHICAL VLSI CIRCUIT DESIGNS” (Docket No. 200311778-1); and U.S. patent application Ser. No. ______ filed ______ entitled “SYSTEM AND METHOD TO LIMIT RUNTIME OF VLSI CIRCUIT ANALYSIS TOOLS FOR COMPLEX ELECTRONIC CIRCUITS” (Docket No. 200311780-1); all of which are hereby incorporated by reference in their entirety.

### BACKGROUND

In the field of integrated circuit (“IC”) design and particularly very large scale integration (“VLSI”) design, it is desirable to test the design before implementation and to identify potential violations in the design. Before implementation on a chip, the information about a design, including information about specific signals and devices that comprise the design, as well as information about connections between the devices, are typically stored in a computer memory. Based on the connection and device information, the designer can perform tests on the design to identify potential problems. For example, one portion of the design that might be tested is the conducting material on the chip. In particular, representations of individual metal segments may be analyzed to determine whether they meet certain specifications, such as electromigration and self-heating specifications. Other tests that may be conducted include electrical rules checking tests, such as tests for noise immunity and maximum driven capacitance, and power analysis tests that estimate power driven by a particular signal and identify those over a given current draw. These tests may be performed using software tools referred to as VLSI circuit analysis tools.

Modern semiconductor IC chips include a dense array of narrow, thin-film metallic conductors, referred to as “interconnects”, that transport current between various devices on the IC chip. As the complexity of ICs continues to increase, the individual components must become increasingly reliable if the reliability of the overall IC is to be maintained. Due to continuing miniaturization of VLSI circuits, thin-film metallic conductors are subject to increasingly high current densities. Under such conditions, electromigration can lead to the electrical failure of interconnects in a relatively short period of time, thus reducing the lifetime of the IC to an unacceptable level. It is therefore of great technological importance to understand and control electromigration failure in thin film interconnects.

Electromigration can be defined as migration of atoms in a metal interconnect line due to momentum transfer from conduction electrons. The metal atoms migrate in the direction of current flow and can lead to failure of the metal line. Electromigration is dependent on the type of metal used and correlates to the melting temperature of the metal. In general, a higher melting temperature corresponds to higher electromigration resistance. Electromigration can occur due to diffusion in the bulk of the material, at the grain boundaries, or on the surface. For example, electromigration in aluminum occurs primarily at the grain boundary due to the higher grain boundary diffusivity over the bulk diffusivity and the excellent surface passivation effect of aluminum oxide that forms on the surface of aluminum when it is exposed to oxygen. In contrast, copper exhibits little electromigration in the bulk and at the grain boundary and instead primarily exhibits electromigration on the surface due to poor copper oxide passivation properties.

Electromigration can cause various types of failures in narrow interconnects, including void failures along the length of a line and diffusive displacements at the terminals of a line that destroy electrical contact. Both types of failure are affected by the microstructure of the line and can therefore be delayed or overcome by metallurgical changes that alter the microstructure. As previously noted, electromigration is the result of the transfer of momentum from electrons moving in an applied electric field to the ions comprising the lattice of the interconnect material. Specifically, when electrons are conducted through a metal, they interact with imperfections in the lattice and scatter. Thermal energy produces scattering by causing atoms to vibrate; the higher the temperature, the more out of place the atom is, the greater the scattering, and the greater the resistivity. Electromigration does not occur in semiconductors, but may in some semiconductor materials that are so heavily doped as to exhibit metallic conduction.

The driving forces behind electromigration are “direct force”, which is defined as the direct action of the external field on the charge of the migrating ion, and “wind force”, which is defined as the scattering of the conduction electrons by the metal atom under consideration. For simplicity, “electron wind force” often refers to the net effect of these two electrical forces. This simplification will also be used throughout the following discussion. These forces and the relation therebetween are illustrated in FIG. 1.

The electromigration failure process is predominantly influenced by the metallurgical-statistical properties of the interconnect, the thermal accelerating process, and the healing effects. The metallurgical-statistical properties of a conductor film refer to the microstructure parameters of the conductor material, including grain size distribution, the distribution of grain boundary misorientation angles, and the inclinations of grain boundaries with respect to electron flow. The variation of these microstructural parameters over a film causes a non-uniform distribution of atomic flow rate. Non-zero atomic flux divergence exists at the places where the number of atoms flowing into the area is not equal to the number of atoms flowing out of that area per unit time such that there exists either a mass depletion (divergence>0) or accumulation (divergence<0), leading to formation of voids and hillocks, respectively. In such situations, failure results either from voids growing over the entire line width, causing line breakage, or from extrusions that cause short circuits to neighboring lines.

The thermal accelerating process is the acceleration process of electromigration damage due to a local increase in temperature. A uniform temperature distribution along an interconnect is possible only absent electromigration damage. Once a void is initiated, it causes the current density to increase in the area around the void due to the reduction in the cross-sectional area of the conductor. The increase of the local current density is referred as “current crowding.” Since joule heating, or “self-heating”, is proportional to the square of current density, the current crowding effect leads to a local temperature rise around the void that in turn further accelerates the void growth. The whole process continues until the void is large enough to result in a line break.

Healing effects are the result of atomic flow in the direction opposite to the electron wind force, i.e., the “back-flow,” during or after electromigration. The back-flow of mass is initiated once a redistribution of mass has begun to form. Healing effects tend to reduce the failure rate during electromigration and partially heals the damage after current is removed. Nonhomogenities, such as temperature and/or concentration gradients, resulting from electromigration damage are the cause of the back-flow.

The effects of electromigration may be slow to develop; however, if an electromigration problem exists, the progress toward a fault is inexorable. The results of an electromigration problem are illustrated in FIGS. 2 and 3. Before current is applied to a section of an IC chip that is first powered up, the metal comprising the interconnects thereof is uniformly distributed, as illustrated in FIG. 2, which illustrates a side view of an interconnect 200. However, in a section of metal that is at risk for electromigration, the mass transport of metal, which occurs in the direction of average current, represented in FIG. 3 by an arrow 301, results in metal moving from a first end 302a of the section to a second end 302b thereof. At some future time, depending on the amount of current flowing through and the thickness of the interconnect 200, electromigration will result in the formation of a void 304 at the first end 302a and a hillock 304 at the second end 302b. Eventually, as previously described, this migration of metal from one end of the wire to the other will result in a failure of the interconnect 200.

As also previously noted, self-heating contributes to the electromigration and actually affects the surrounding wires as well. As a wire carries current, it will heat up, thereby lowering the limits for electromigration in surrounding wires as well as the wire under consideration. It is important, therefore, to consider the effects of both electromigration and self-heating (collectively “EM/SH”) when analyzing and verifying the reliability of an IC chip design.

Typically, circuit analysis tools (including, e.g., the EM/SH analysis tools) operate on what is known as a “flat RC netlist” that is a flattened representation of a hierarchical IC design. As VLSI designs continue to grow in size and become increasingly complex, flattening a hierarchical netlist gives rise to capacity limitations, thereby necessitating a piecemeal approach to circuit analysis.

### SUMMARY

One embodiment is a method for enabling a first circuit analysis tool to flatten a hierarchical design for processing by a second circuit analysis tool. The method comprises reading a logical representation of the hierarchical design; and, for each block of the hierarchical design, loading RC information for the block from an RC model of the hierarchical design and writing a flat representation of each instantiation of the block to the second circuit analysis tool.

### BRIEF DESCRIPTION OF THE DRAWINGS

FIG. 1 illustrates the driving forces behind electromigration, including direct force and wind force;

FIGS. 2 and 3 illustrate the effects of electromigration on an IC chip interconnect;

FIG. 4 is a flow diagram of a reliability verification tool (“RVT”) in one embodiment;

FIG. 5 is a block diagram illustrating hierarchical design of a VLSI circuit;

FIG. 6 is a schematic diagram illustrating the concept of nets in a VLSI circuit;

FIG. 7 is a block diagram of a system for flattening a hierarchical design;

FIG. 8 is a flowchart of the operation of one embodiment of a method for avoiding capacity limitations during flattening of hierarchical designs in VLSI circuit analysis tools; and

FIG. 9 is a flowchart of the operation of another embodiment of a method for avoiding capacity limitations during flattening of hierarchical designs in VLSI circuit analysis tools.

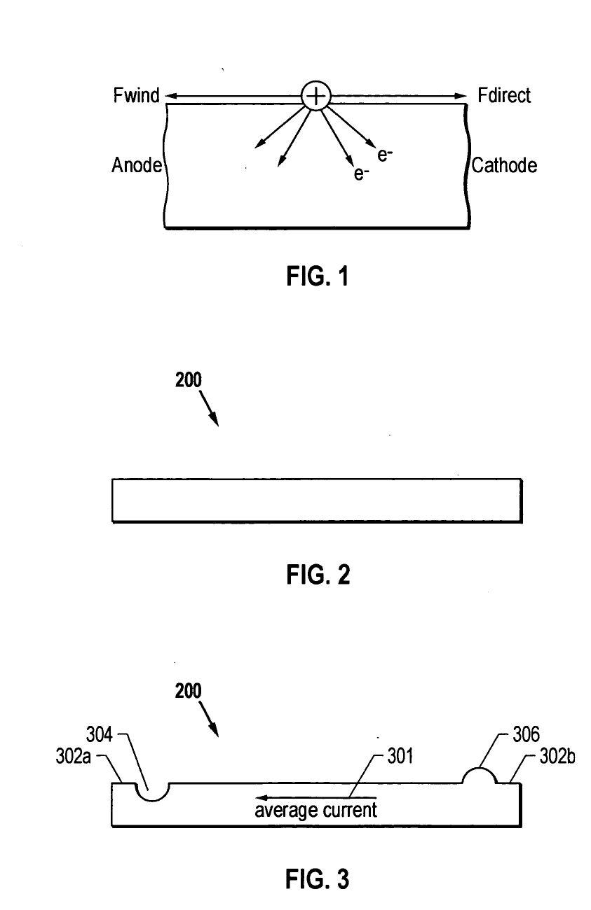

### DETAILED DESCRIPTION OF THE DRAWINGS

In the drawings, like or similar elements are designated with identical reference numerals throughout the several views thereof, and the various elements depicted are not necessarily drawn to scale.

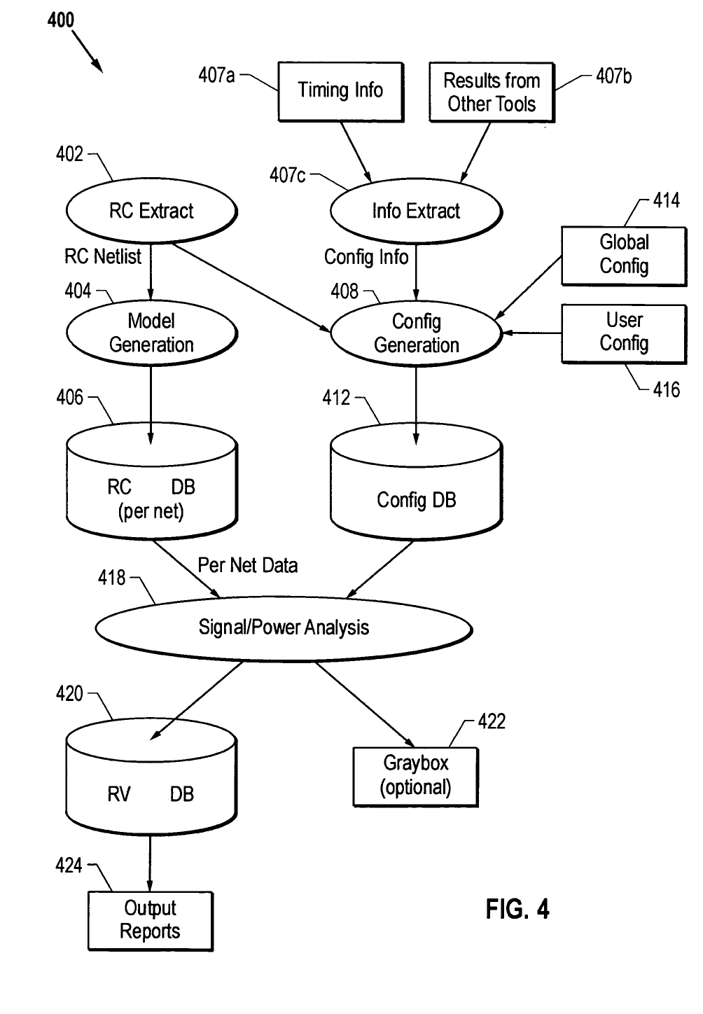

FIG. 4 is a flow diagram of one embodiment of a VLSI circuit analysis tool, specifically, a reliability verification tool (“RVT”) 400. In the illustrated embodiment, the RVT 400 is designed to find areas of an IC block layout that may have electromigration and/or self-heating (“EM/SH”) risks. The output files produced by the RVT 400 are useful for viewing violations in a text manner and a violations shapes representation can be loaded on top of the block artwork to provide a visual representation of the problem areas and the changes proposed by the RVT 400 to correct those problems.

Specifically, the RVT 400 is designed to assist designers with the challenging task of identifying potential EM/SH problem areas in their designs. Since the rules of electromigration are not always intuitive and problem areas can be hard to spot, the RVT 400 is an important tool for determining if the design has any violations that, if not discovered and corrected, could lead to future chip failure. This is due to the fact that faults that electromigration can produce develop slowly over time until the metal finally breaks.

In one embodiment, the RVT 400 provides a designer with a clear, easy-to-follow approach to identifying EM/SH violations. Theoretically, design rules should prevent most wires from risk of electromigration, but cases still exist in which there may be a problem. By running the RVT 400 on a design block, a designer can ensure that the wires in the block will be reliable in the long term and will not cause a chip failure. The RVT 400 accomplishes this by calculating the currents through each piece of metal and each contact array on the chip. It compares these currents with certain process rules describing the maximum current that a given width of metal or set of contacts may carry. Any currents that do not meet the limits are reported as violations.

In order to “calculate the currents”, as indicated above, the RVT 400 may be run in either “signal” or “power” mode to analyze metal connecting signals or to analyze the power grid. These two runs are performed separately to give better capacity and performance. In signal analysis, the RVT 400 first separates the chip into individual stages. A stage is a set of resistors that connect one or more driver FETs (i.e., those FETs that are connected to a supply) to the gates of one or more receiver FETs. These connections may pass through the channels of any number of pass FETs in the process. The RVT 400 takes each of these stages and attempts to simulate the likely combinations of on and off FETs, as dictated by logic configuration, taking the worst case currents determined over all of the simulations. The currents are then checked against the EM/SH rules.

In power analysis, the RVT 400 treats each power grid rail as its own stage. It uses the current through FETs connected to the rail determined in a previous signal analysis run to load the power grid. After simulating the grid with the load currents, it checks the currents calculated through each resistor against the EM/SH rules.

FIG. 4 illustrates the overall flow of data and control through the RVT 400. The diagram illustrated in FIG. 4 illustrates the flow that applies to both signal and power analysis. The RVT 400 relies on a special RC extract 402 to perform its analysis. In one embodiment, the RC extract 402 provides highly detailed resistance values to enable the EM/SH rules to be applied correctly.

A Model Generation module 404 processes the extracted RC information from the RC extract 402 into an RC database (“DB”) 406 for each block. This allows easy access of the information on a per-net basis so that only the nets for a particular stage, as opposed to the entire model, need to be loaded into memory. The RC DB 406 is reused from run to run of the RVT 400 and is only regenerated when a new extract is performed.

The RVT 400 also relies on configuration information, such as timing information 407a and results from other analysis tools 407b, extracted from other sources by an info extract module 407c. These sources produce configuration files that, once extracted, are read in by a configuration generation phase 408 of the RVT 400. As previously noted, the extracted configuration information input to the configuration generation phase 408 may include information extracted from circuit annotation, timing information and additional circuit properties from transistor-level static timing analysis tool runs, information extracted from circuit recognition, and node activity factor (“AF”) information.

In one embodiment, as indicated above, the RVT 400 has the ability to read some configuration information pertaining to logical relationships within the design, such as those logic configuration commands listed below. These commands may be specified via configuration files or via annotations directly associated with schematic representations of the design. Each of the block properties' values is a list of signal names, each of which may be prefixed by “!”, indicating the opposite logic sense should be applied to that signal. The block properties include:
set_high instructs the analysis tool to set the specified net(s) to logic 1
set_low instructs the analysis tool to set the specified net(s) to logic 0
unset instructs the analysis tool to that any previous set_high or set_low information should be removed from the specified net(s)
merge_nodes instructs the analysis tool to treat all of the specified nets as having the same logical value
mutex instructs the analysis tool that exactly one of the specified nets should have a value of 1
imutex instructs the analysis tool that no more than one of the specified nets should have a value of 1
ifthen instructs the analysis tool as to the logical relationship of nets based on the state of the first net
forbid forbids the specified combination of nets

In one embodiment, as also indicated above, the RVT 400 has two methods for determining the activity factor on nodes. Both of these may be overridden by user configuration information if desired. The first such method is to use the default activity factors according to the node's type as determined by circuit recognition and a transistor-level static timing analysis tool. The second is to read explicit activity factors for each node. This can either specify a user-created file for activity factors or it may run some other tool to generate activity factors. If this method is selected, any node that does not have an activity factor explicitly specified therefore will default to one based on node type.

Similar to the Model Generation module 404, the Configuration Generation module 408 consolidates all of the configuration information at the beginning of a run and places this in a Config DB 412 for easy per-net access. The Configuration Generation module 408 reads a global configuration file 414 specified by a tool administrator and a user configuration file 416 specified by a user on a per-block basis. Both of these configuration files 414, 416, may be used to override the extracted configuration if necessary.

In addition to combining all of the configuration information together in a per-net fashion, the Configuration Generation module 408 also propagates some logic configuration through a process referred to as “transitive closure”, as described in related U.S. patent application Ser. No. ______ (Docket No. 200311735-1), which has been incorporated by reference in its entirety.

A signal/power analysis module 418 performs the main work of the RVT 400. It handles one stage at a time, calculating the currents through each resistor and applying the EM/SH rules. It generates both a Reliability Verification database (“RV DB”) 420, which contains all of the information it calculates, and an optional “graybox” description 422 for the file. The RV DB 420 is subsequently processed to generate the various output reports that users actually read. In order to improve performance, the analysis may be run on serval machines in parallel. As each stage is independent, requiring only the information on the nets it contains, the analysis is easily parallelizable.

It should be noted that when the RVT 400 generates a graybox 422 for a given block, it will create both a netlist, or “BDL”, file and also a config file containing all configuration information for the ports of the graybox. This allows various configuration (such as node types or activity factors) to be propagated up from a graybox. The graybox information is read in by the Model Generation module 404 and the Configuration Generation module 410 when the graybox 422 is used in the analysis of a parent block.

The RVT 400 generates a variety of output reports 424 such as a text file containing a list of all resistors that failed the EM/SH rules, along with any stages that were discarded. The RVT 400 also generates layout shapes that highlight the violations at each level of the hierarchy. The violations shapes are all stored as blocks along with the rest of the output files 424.

Running a power analysis using the RVT 400 relies on the user to have previously run a signal analysis with the RVT at or above the level on which a power analysis is to be run. During the RVT signal analysis, the default is to write out the average case and worst case current through all driver FETs (i.e. any FETs with a source or drain of VDD or GND) to a “signal_rvdb” file so that power analysis can use those currents. This also includes writing currents through output drivers, which means that these stages are analyzed for currents, but no EM/SH checks are done on those stages and no resistor currents are reported for them.

The average and worst case currents are calculated in the signal run as follows. The worst case current is simply the worst case current through each driver FET seen during the signal run using the same activity factors (“AF”) and drive fights (“DF”) signal run. This current will be used in the worst case RVT power analysis, which is performed on the low level metal and via layers as specified in the global configuration file 414.

Calculating the average case current is a bit more complicated. The average case current is used to check EM/SH on the upper level metal and via layers as specified in the global configuration file 414, thus it is very important to get the current for the entire stage correct and not as important to get the current for each driver FET correct. Thus, for the average case power analysis, it is not advisable to use the worst case current. The global configuration file 414 may also specify different default activity factors for different node types to use with power analysis. For example, changing the default activity factor for static nodes to 0.2 instead of using the 0.5 used for worst case signal analysis, more accurately represents the power drawn.

During an RVT power analysis run, the RVT 400 collects the driver FET currents calculated during the RVT signal run, as described above, generates a power SPICE deck, simulates that deck, checks each resistor in the simulated grid against EM/SH rules, and generates output files, including violations files, and power grayboxes if requested to do so.

VLSI design relies heavily on hierarchical description, primarily because large amounts of design detail can be concealed or compactly represented within a such a description. In view of the complexity of most circuits, a complete design is often represented as a collection of component aggregates further divided into subaggregates in a hierarchical and recursive manner. These aggregates are typically referred to as “cells” or “blocks”. The use of a block at a hierarchical level is referred to as an “instance”. Graphically, each instance of a block in a higher hierarchical level can be represented as a footprint designating the location of the instance. The footprint may or may not show the block's contents.

The term “leaf block” refers to a block that is at the bottom of the hierarchy; that is, a block that does not contain any instances of any other blocks. The term “root block” refers to the one block that is at the top of the hierarchy and therefore is not contained as an instance in any other block. The term “composition block” is used to refer to each of the remaining blocks, which comprise the body of the hierarchy. Hierarchy is conventionally discussed in terms of depth, with the leaf blocks comprising the deepest, or lowest, layer and the root block comprising the highest layer. A design with no hierarchy is said to be flat. Certain types of CAD tools require that a design be flat because they are unable to handle hierarchical descriptions. A circuit that has all of its block instances recursively replaced with their respective contents is said to have been flattened.

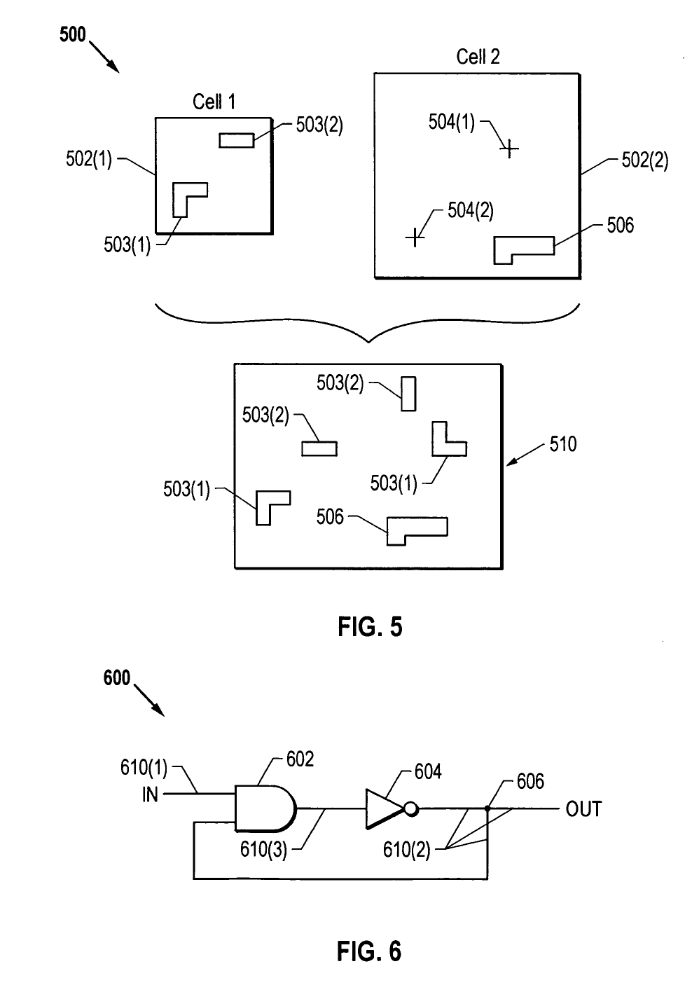

FIG. 5 illustrates a hierarchical design of a VLSI circuit, designated by reference numeral 500. The design 500 comprises two blocks, respectively designated by reference numerals 502(1) and 502(2). The block 502(1) includes two circuits 503(1), 503(2). The block 502(2) is a higher hierarchical level block than the block 502(1) and includes two instantiations of the block 502(1), as represented by crosshatches (“+”) designated by reference numerals 504(1) and 504 (2). For purposes of example, it will be assumed that the instantiation 504(1) is rotated 90 degrees with respect to the instantiation 504(2). The block 502(2) also includes an additional circuit 506. A flattened representation of the block 502(2) is designated in FIG. 5 by a reference numeral 510.

In electronics, components are viewed in terms of how they move signals back and forth across wires. All components have locations that attach to wires that make a connection to other locations on other components. Accordingly, an implicit requirement of VLSI design is that components are connected and connections carry information about the relationship of the connected components.

A related concept is that of a “net”, which is a single electrical path in a circuit that has the same value at all of its points. Any collection of wires that carries the same signal between components comprises a net. Moreover, if a component passes the signal though without altering it, such as is the case with a terminal, the net continues on subsequently connected wires. Otherwise, the net terminates a component that alters the signal and a new net begins on the other side of that component. A component that passes a signal unaltered is referred to as a passive component; a component that alters a signal that passes through is referred to as an active component.

FIG. 6 further illustrates the concept of nets. As shown in FIG. 6, a circuit 600 comprises two active components, including an AND gate 602 and an inverter 604, and one passive component; i.e., a terminal 606. The circuit 600 also comprises three nets 610(1), 610(2), and 610(3). The first and second nets 610(1) and 610(2) are input and output nets, respectively. The third net 610(3) is an internal net that connects the output of the AND gate 602 to the input of the inverter 604.

Designers typically want to view an entire net to determine the path of a particular signal, which will identify the origin of the signal and the components that use the signal as input. Additionally, viewed abstractly, a circuit is merely a collection of gating components and the connections therebetween. A netlist omits the passive components and actual geometry of a circuit layout. Therefore, if a design tool is concerned only with the general functionality of a design, the collection of nets and active components supplies all of the information needed by the tool.

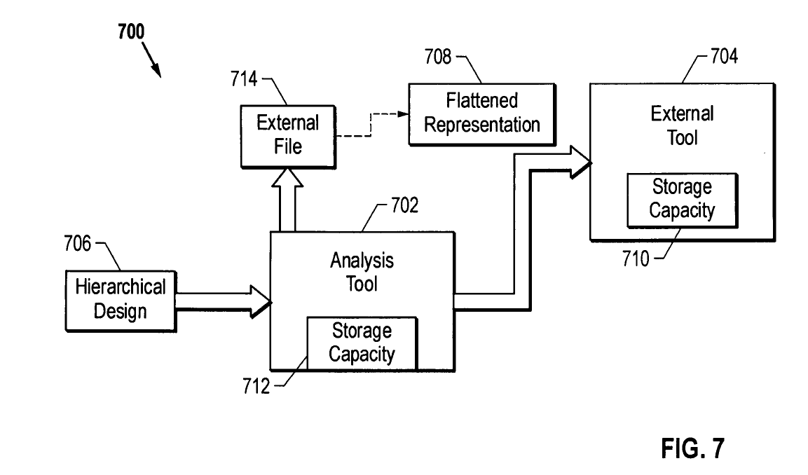

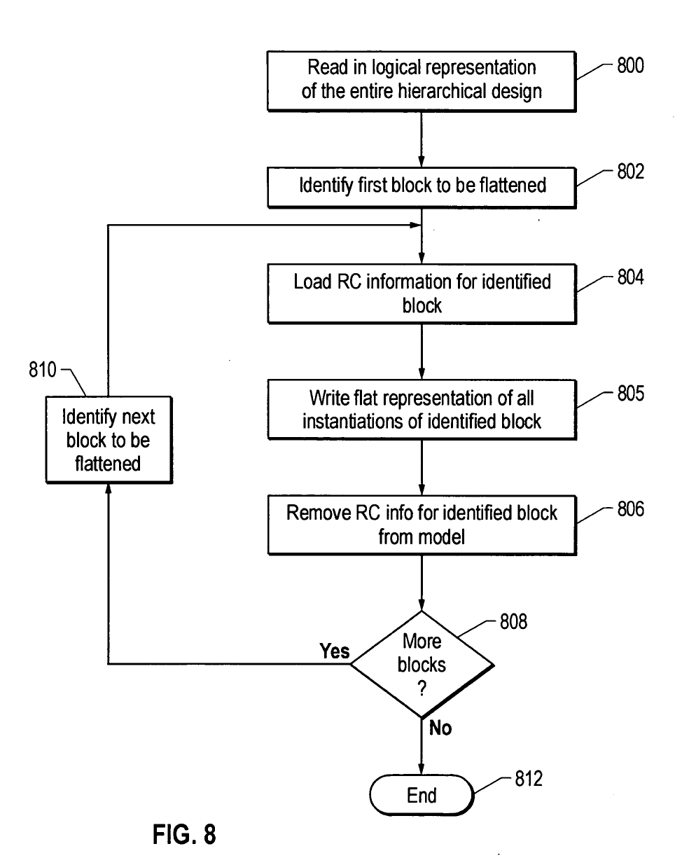

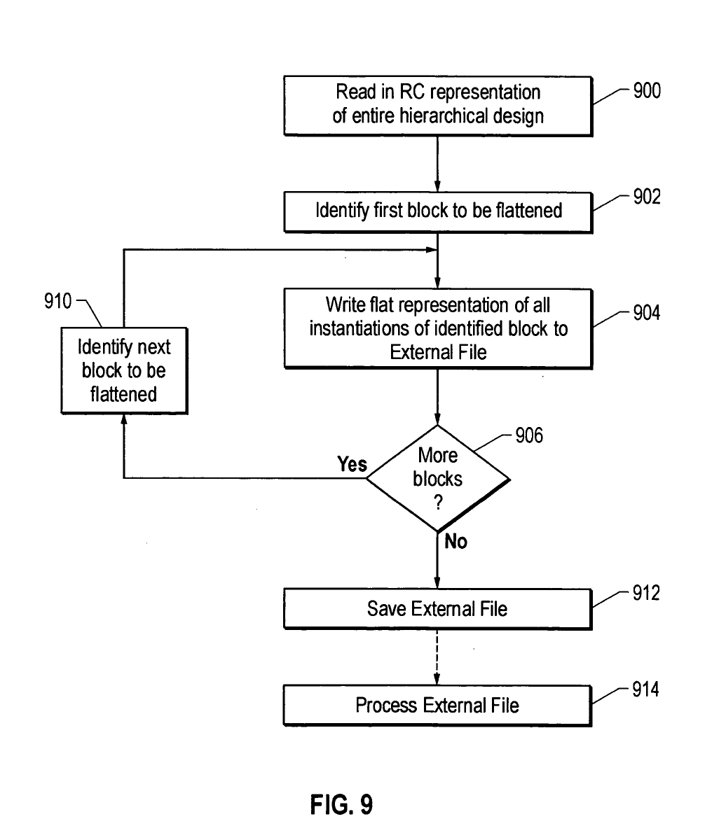

As previously noted, many CAD tools, require a design to be flattened prior to operating thereon. FIG. 7 illustrates a system 700 comprising an analysis tool 702, which may be, for example, the RVT 400, connected to an external simulation tool 704. The illustrated embodiment, in a manner to be described in detail below, flattens a hierarchical design 706 and provides the resulting flattened representation 708 to the simulation tool 704. It will be assumed that a storage capacity 710 of the external simulation tool 704 is greater than a storage capacity 712 of the analysis tool 702. It will be further assumed that the storage capacity 712 is insufficient to store the entire flattened representation 708. The methods illustrated below with reference to FIGS. 8 and 9 can be implemented in situations such as that illustrated in FIG. 7 to overcome the capacity limitations of the tool 702 and enable it to provide a flattened representation, such as the representation 708, to an external simulation tool, such as the tool 704.

FIG. 8 is a flowchart of the operation of one embodiment of a method for avoiding capacity limitations during flattening of hierarchical designs in VLSI circuit analysis tools. As will become apparent, the flattening process illustrated in FIG. 8 occurs “on-the-fly”. In step 800, the logical representation of the entire hierarchical design to be analyzed, such as the design 706, is read into the tool 702. In step 802, a first block to be flattened is identified. In step 804, the RC information for the block is loaded. In step 805, a flat representation of all instantiations of the block under consideration is written to the external tool 704. In step 806, the RC information for the block under consideration is removed from the model. In step 808, a determination is made whether there are more blocks to be flattened. If so, execution proceeds to step 810, in which a next block to be flattened is identified, and then returns to step 804. If a negative determination is made in step 808, indicating that the entire design has been flattened, execution terminates in step 812.

It will be recognized that the order in which blocks are processed can be performed in various manners. For example, a “breadth first” process can be employed, in which all blocks in a level are flattened and the RC representations thereof removed from the model before moving on to the “child” blocks thereof. Alternatively, a “depth first” process can be employed, in which the blocks of a net at each hierarchical level are processed before processing begins on the blocks of another net in a similar fashion.

FIG. 9 is a flowchart of the operation of another embodiment of a method for avoiding capacity limitations during flattening of hierarchical designs in VLSI circuit analysis tools. In step 900, the RC representation of the entire hierarchical design to be analyzed, such as the design 706, is read into the tool 702. In step 902, a first block to be flattened is identified. In step 904, a flat representation of all instantiations of the block under consideration is written to an external file 712 (FIG. 7). In step 906, a determination is made whether there are more blocks to be flattened. If so, execution proceeds to step 910, in which a next block to be flattened is identified, and then returns to step 904. If a negative determination is made in step 906, indicating that the entire design has been flattened, execution proceeds to step 912, in which the external file is saved for later processing by the tool 704 in step 914.

The embodiments illustrated and described herein circumvent-some of the limitations of conventional analysis tools by relying on an external simulator to perform a simulation and creating a flattened netlist on the fly, instead of in memory. This enables the analysis tool to have a much greater capacity than previously possible, particularly if the capacity of the simulator is significantly greater than that of the analysis tool.

An implementation of the invention described herein thus provides system and method to avoid capacity limitations during flattening of hierarchical designs in VLSI circuit analysis tools. The embodiments shown and described have been characterized as being illustrative only; it should therefore be readily understood that various changes and modifications could be made therein without departing from the scope of the present invention as set forth in the following claims.

1. A method for enabling a first circuit analysis tool to flatten a hierarchical design for processing by a second circuit analysis tool, the method comprising:
reading a logical representation of the hierarchical design; and
for each block of the hierarchical design:
loading RC information for the block from an RC model of the hierarchical design; and
writing a flat representation of each instantiation of the block to the second circuit analysis tool.

2. The method of claim 1 further comprising deleting the RC information for the block from the RC model.

3. The method of claim 1 further comprising flattening all blocks in a first hierarchical level of the hierarchical design before flatting a block in a next hierarchical level of the hierarchical design.

4. The method of claim 1 further comprising flattening all blocks of a net of the hierarchical design before flattening a block of another net of the hierarchical design.

5. The method of claim 4 wherein at least one of the blocks of the net is in a different hierarchical level than at least one other one of the blocks of the net.

6. The method of claim 1 wherein a storage capacity of the second circuit analysis tool is greater than a storage capacity of the first circuit analysis tool.

7. A method for enabling a first circuit analysis tool to flatten a hierarchical design for processing by a second circuit analysis tool, the method comprising:
reading an RC representation of the hierarchical design; and
for each block of the hierarchical design, writing a flat representation of the block to an external file.

8. The method of claim 7 further comprising, responsive to flattening of all blocks comprising the hierarchical design, saving the external file.

9. The method of claim 8 wherein the external file is saved to a memory of the second circuit analysis tool.

10. The method of claim 7 further comprising, responsive to flattening of all blocks comprising the hierarchical design, the second circuit analysis tool processing the external file.

11. The method of claim 7 wherein a storage capacity of the second circuit analysis tool is greater than a storage capacity of the first circuit analysis tool.

12. A system for flattening a hierarchical design to be processed by an external circuit analysis tool, the system comprising:
means for reading a logical representation of the hierarchical design;
means for loading RC information for a block of the hierarchical design from an RC model of the hierarchical design; and
means for writing a flat representation of each instantiation of the block to the second circuit analysis tool.

13. The system of claim 12 further comprising means for deleting the RC information for the block from the RC model subsequent to the flattening.

14. The system of claim 12 wherein all blocks in a first hierarchical level of the hierarchical design are flattened before any blocks in a next hierarchical level of the hierarchical design are flattened.

15. The system of claim 12 wherein all blocks of a net of the hierarchical design are flattened before any blocks of another net of the hierarchical design are flattened.

16. The system of claim 15 wherein at least one of the blocks of the net is in a different hierarchical level than at least one other one of the blocks of the net.

17. The system of claim 12 further comprising a storage device for storing a logical representation of the hierarchical design.

18. The system of claim 12 further comprising a storage device for storing an RC model of the hierarchical design.

19. The system of claim 12 wherein a storage capacity of the external circuit analysis tool is greater than a storage capacity of the system.

20. A system for flattening a hierarchical design to be processed by an external circuit analysis tool, the system comprising:
means for reading an RC representation of the hierarchical design;
means for writing a flat representation of each block of hierarchical design to an external file.

21. The system of claim 20 further comprising, means responsive to flattening of all blocks of the hierarchical design for saving the external file.

22. The system of claim 20 further comprising a storage device for storing a logical representation of the hierarchical design.

23. The system of claim 20 further comprising a storage device for storing an RC model of the hierarchical design.

24. The system of claim 20 wherein a storage capacity of the external circuit analysis tool is greater than a storage capacity of the system.

25. The system of claim 20 further comprising means for saving the external file to a memory of the circuit analysis tool.

26. A computer-readable medium operable with a computer for flattening a hierarchical design to be processed by an external circuit analysis tool, the medium having stored thereon:
computer-executable instructions for reading a logical representation of the hierarchical design;
computer-executable instructions for loading RC information for a block of the hierarchical design from an RC model of the hierarchical design; and
computer-executable instructions for writing a flat representation of each instantiation of the block to the second circuit analysis tool.

27. The medium of claim 26 further having stored thereon computer-executable instructions for deleting the RC information for the block from the RC model subsequent to the flattening.

28. The medium of claim 26 further having stored thereon computer-executable instructions for flattening all blocks in a first hierarchical level of the hierarchical design are flattened before any blocks in a next hierarchical level of the hierarchical design are flattened.

29. The medium of claim 26 further having stored thereon computer-executable instructions for flatting all blocks of a net of the hierarchical design before any blocks of another net of the hierarchical design are flattened.

30. The medium of claim 29 wherein at least one of the blocks of the net is in a different hierarchical level than at least one other one of the blocks of the net.

31. A computer-readable medium operable with a computer for flattening a hierarchical design to be processed by an external circuit analysis tool, the medium having stored thereon:
computer-executable instructions for reading an RC representation of the hierarchical design; and
computer-executable instructions for writing a flat representation of each block of hierarchical design to an external file.

32. The medium of claim 31 further having stored thereon computer-executable instructions responsive to flattening of all blocks of the hierarchical design for saving the external file.

33. The medium of claim 31 further having stored thereon computer-executable instructions for saving the external file to a memory of the circuit analysis tool.
